(19) United States
(12) Patent Application Publication
(10) Pub. No.: US 2021/0166853 A1
(43) Pub. Date: Jun. 3, 2021

(54) WIDE-BAND ACTUATOR

(71) Applicant: CK MATERIALS LAB CO., LTD., Seoul (KR)

(72) Inventors: Hyeong Jun Kim, Seoul (KR); Jong Hun Lee, Seoul (KR); Jong Ki Lee, Seoul (KR)

(21) Appl. No.: 16/769,564

(22) PCT Filed: Nov. 7, 2019
(86) PCT No.: PCT/KR2019/015013

§ 371 Date: Jun. 3, 2020

(30) Foreign Application Priority Data
Nov. 30, 2018 (KR) 10-2018-0151916

(51) Int. Cl. H01F 7/16; H01F 7/10; H01F 7/08; B06B 1/04

(52) U.S. Cl. CPC H01F 7/16; B06B 1/04; H01F 7/081; H01F 7/10

(57) ABSTRACT

A wide-band actuator includes a cylindrical housing having an inner space, a yoke member provided in the inner space, the yoke member including a cylindrical inner yoke protruding upward from the center of the bottom of the inner space, a hollow radial magnet provided to enclose the outer circumferential surface of the inner yoke, a moving body including a cylindrical mass body provided to enclose the outer circumferential surface of the radial magnet, and a coil part provided along the circumference of the mass body, and an elastic member configured to elastically support the moving body from one side of the inner space.

### TECHNICAL FIELD

Embodiments relate to a wide-band actuator.

### BACKGROUND ART

In general, a linear resonant actuator (LRA) is principally used as a haptic device. The LRA is driven in a manner that maximizes an intensity of vibration using a resonant frequency generated by a weight body connected to a magnetic circuit and an elastic spring.

The conventional LRA is directed to simply transferring vibration and needs to use a resonant frequency determined by a weight body and an elastic member for effective vibration.

A conventional haptic device may provide vibration only in a predetermined resonant frequency band and have difficulty in implementing vibration in an ultra-low frequency band (20 Hz or less) or a high frequency band of 1 kHz or higher.

Thus, there is a need to develop a haptic device that may provide various tactile sensations by vibrating in a wide frequency band, rather than simply vibrating at one resonance frequency.

The above description has been possessed or acquired by the inventor(s) in the course of conceiving the present invention and is not necessarily an art publicly known before the present application is filed.

### DISCLOSURE OF INVENTION

### Technical Goals

An aspect provides a wide-band actuator.

### Technical Solutions

According to an aspect, there is provided a wide-band actuator including a cylindrical housing having an inner space, a yoke member provided in the inner space, the yoke member including a cylindrical inner yoke protruding upward from the center of the bottom of the inner space, a hollow radial magnet provided to enclose the outer circumferential surface of the inner yoke, a moving body including a cylindrical mass body provided to enclose the outer circumferential surface of the radial magnet, and a coil part provided along the circumference of the mass body, and an elastic member configured to elastically support the moving body from one side of the inner space.

The inner circumferential surface of the radial magnet and the inner yoke may face each other, the outer circumferential surface of the radial magnet and the coil part may face each other, and the inner circumferential surface and the outer circumferential surface of the radial magnet may have opposite polarities.

The length of the radial magnet measured in a vibration direction of the moving body may be greater than a distance between the external diameter and the internal diameter of the radial magnet.

The yoke member may further include an outer yoke provided along the inner circumferential surface of the inner space, and a lower yoke provided on the bottom of the inner space, and the coil part may be disposed in an accommodation space among the inner yoke, the outer yoke, and the lower yoke.

The wide-band actuator may further include a pole piece provided to cover the top surface of the radial magnet.

Based on a vertical direction, the center point of the coil part may be at an upper position than the center point of the radial magnet.

Based on a vertical direction, the upper end of the coil part may be at a lower position than the upper end of the pole piece.

The elastic member may be provided in the shape of a flat plate connecting the inner space of the housing and the mass body in a plane direction perpendicular to a vertical direction.

The housing may include a lower housing enclosing the circumference of the yoke member, and a guide housing with the lower side connected to the lower housing and the yoke member, the guide housing including a stepped portion recessed on the inner circumferential surface of the upper side, and the edge of the elastic member may be provided in the stepped portion of the guide housing.

The housing may further include a hollow upper housing provided in the stepped portion to pressurize and fix the edge of the elastic member provided in the stepped portion from the top.

The mass body may include a cylindrical insertion member with the lower side including a groove to accommodate the radial magnet and the inner yoke, and a protruding member protruding upward from the center of the insertion member.

The protruding member may protrude toward the upper side of the housing.

The elastic member may be provided in the shape of a flat plate connecting the inner space of the housing and the protruding member in a plane direction perpendicular to a vertical direction.

The wide-band actuator may further include a controller configured to apply an alternating current to the coil part, wherein when the controller applies a sine wave of a frequency band between 100 Hz to 1 kHz to the coil part, the moving body may form a vibration force of 0.2 G or greater.

The wide-band actuator may further include a controller configured to apply an alternating current to the coil part, wherein when the controller applies an alternating current of a rectangular waveform of a frequency band between 1 Hz to 20 Hz to the coil part, a cumulative impulse formed by the moving body within a unit interval of 50 ms may be 3 mNs or greater, such that a haptic effect corresponding to tapping may be formed.

According to an aspect, there is provided a wide-band actuator including a housing having an inner space, a yoke member including an outer yoke provided along the inner circumferential surface of the inner space, and an inner yoke protruding upward from the bottom of the inner space, a radial magnet provided to enclose the outer circumferential surface of the inner yoke, a moving body including a mass body configured to move in a protruding direction of the inner yoke in a separation space formed between the radial magnet and the outer yoke, and a coil part provided in the mass body, and an elastic member configured to elastically support the moving body from one side of the inner space.

The yoke member may further include a lower yoke connecting the bottom of the outer yoke and the bottom of the inner yoke.

According to an aspect, there is provided a wide-band actuator including a housing having an inner space, a yoke member including an outer yoke provided along the inner circumferential surface of the inner space, and an inner yoke protruding upward from the bottom of the inner space, a radial magnet provided to enclose the outer circumferential surface of the inner yoke, a moving body including a mass body configured to move in a protruding direction of the inner yoke in a separation space formed between the radial magnet and the outer yoke, and a coil part provided in the mass body, and a pole piece provided to cover the top surface of the radial magnet.

According to an aspect, there is provided a wide-band actuator including a lower housing having an inner space, a yoke member to be inserted into the lower housing, the yoke member including a first step recessed on the outer circumferential surface of the upper side thereof, a radial magnet connected to the yoke member, a guide housing with the lower end portion to be coupled to a mounting groove formed by the lower housing and the step, an elastic member seated in a second step recessed on the inner circumferential surface of the upper side of the guide housing, and a moving body connected to the elastic member, the moving body including a coil part configured to interact with the radial magnet.

The wide-band actuator may further include an upper housing to be inserted into the second step to fix the elastic member, in a state in which the elastic member is seated in the second step.

The upper housing may have an opened top, and the moving body may further include a protruding member exposed through the opened top of the upper housing.

### Effects

According to an embodiment, a wide-band actuator may effectively control a density and a direction of magnetic flux through a radial magnet and effectively control a magnetic leakage.

According to an embodiment, a wide-band actuator may provide various haptic effects driven in a wide band from an ultra-low frequency band to a high frequency band.

### BRIEF DESCRIPTION OF DRAWINGS

FIG. 1 is a cross-sectional view of a wide-band actuator according to an embodiment.

FIG. 2 is an exploded view of a wide-band actuator according to an embodiment.

FIG. 3 is a view illustrating a direction and a magnitude of magnetism formed by a wide-band actuator according to an embodiment.

FIG. 4 is a graph illustrating a vibration force formed by a displacement of a moving body according to an embodiment.

FIG. 5 is a graph illustrating vibration forces formed for respective driving frequencies of a conventional linear resonant actuator (LRA) and a wide-band actuator according to an embodiment.

FIG. 6 is a graph illustrating vibration forces measured when sine waves with frequencies less than 20 Hz are applied to a wide-band actuator according to an embodiment.

FIG. 7 is a graph illustrating an example of forming a haptic effect corresponding to tapping when a 5 Hz rectangular wave is applied to a wide-band actuator according to an embodiment.

FIG. 8 is a graph illustrating impulses generated when rectangular waves of different ultra-low frequency bands are applied to a wide-band actuator according to an embodiment.

FIG. 9 illustrates graphs of vibration forces formed in Case A where a 5 Hz rectangular wave is applied to a wide-band actuator according to an embodiment and in Case B where a sine wave is applied thereto.

FIG. 10 illustrates graphs of vibration forces formed when rectangular waves of ultra-low frequency bands are applied to a wide-band actuator according to an embodiment.

### BEST MODE FOR CARRYING OUT THE INVENTION

Hereinafter, embodiments of the present disclosure will be described with reference to the accompanying drawings. Regarding the reference numerals assigned to the components in the drawings, it should be noted that the same components will be designated by the same reference numerals, wherever possible, even though they are shown in different drawings. Also, in the description of the embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the embodiments described above and an element having a common function. Unless otherwise mentioned, the descriptions on the embodiments may be applicable to the following embodiments and thus, duplicated descriptions will be omitted for conciseness.

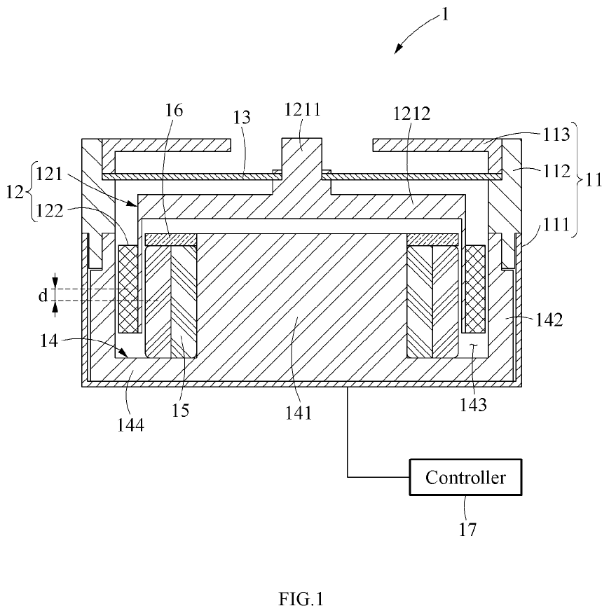

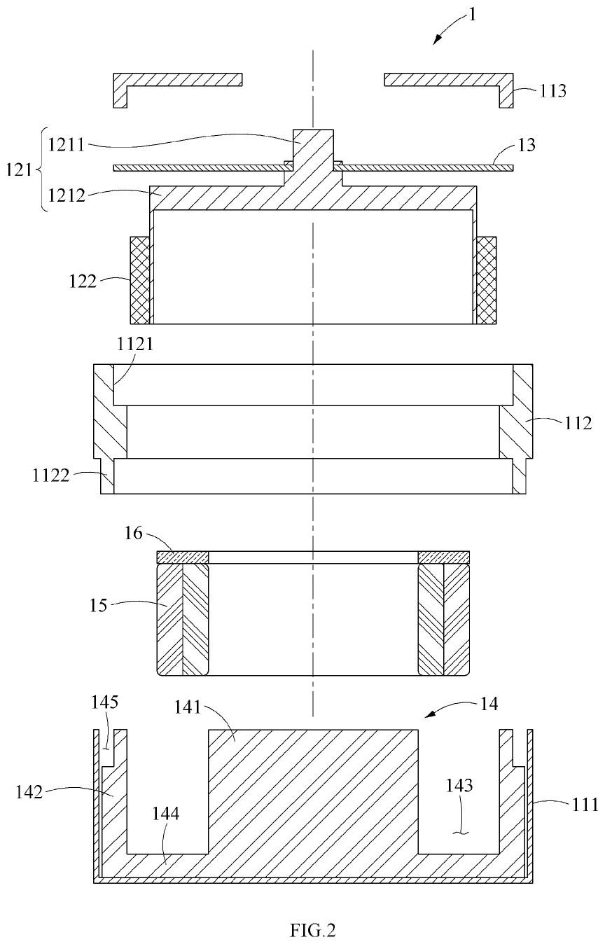

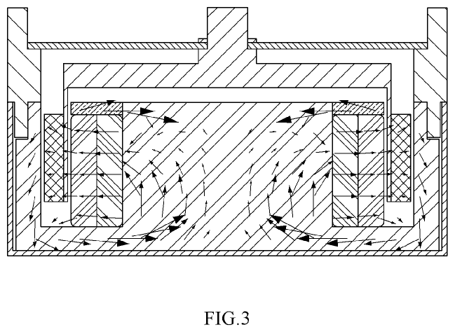

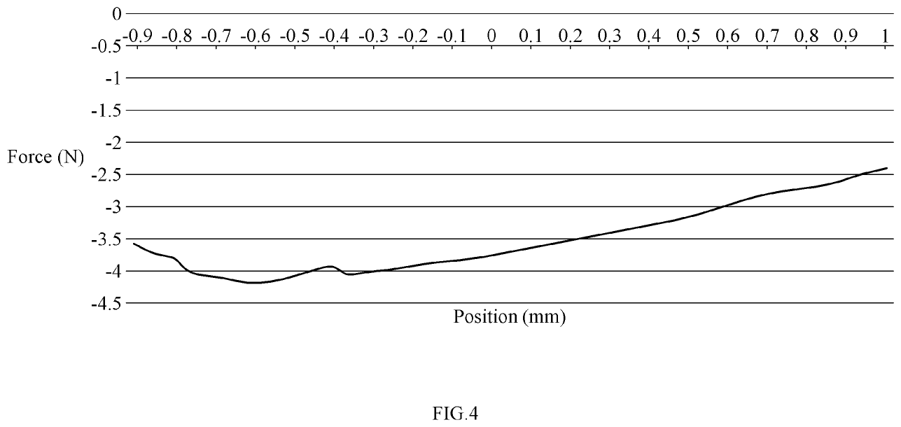

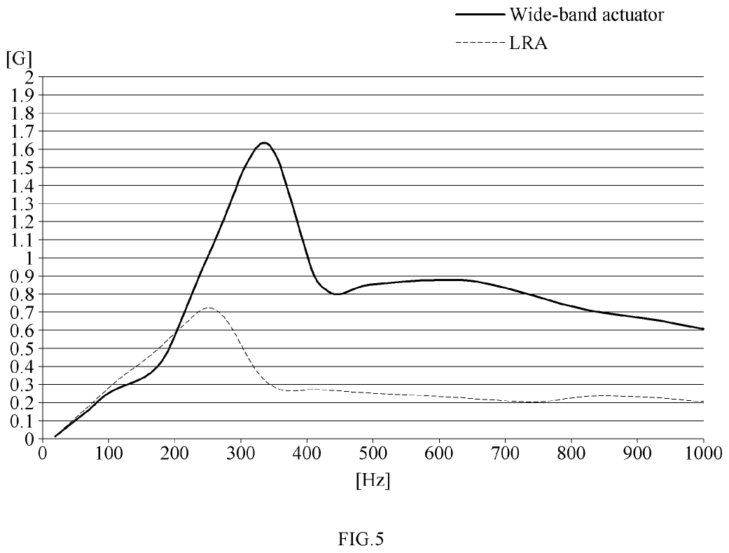

FIG. 1 is a cross-sectional view of a wide-band actuator according to an embodiment, FIG. 2 is an exploded view of the wide-band actuator according to an embodiment, FIG. 3 is a view illustrating a direction and a magnitude of magnetism formed by the wide-band actuator according to an embodiment, FIG. 4 is a graph illustrating a vibration force formed by a displacement of a moving body according to an embodiment, and FIG. 5 is a graph illustrating vibration forces formed for respective driving frequencies of a conventional linear resonant actuator (LRA) and a wide-band actuator according to an embodiment.

Referring to FIGS. 1 through 5, a wide-band actuator 1 may provide various haptic effects driven in a wide band from an ultra-low frequency band of less than 20 Hz to a high frequency band of 500 Hz or 1 kHz or higher.

For example, the wide-band actuator 1 may include a housing 11, a yoke member 14, a radial magnet 15, a moving body 12, an elastic member 13, and a controller 17.

The housing 11 may be a cylindrical member having an inner space. For example, the inner space of the housing 11 may be provided in the shape of a cylinder.

The housing 11 may include a lower housing 111, a guide housing 112, and an upper housing 113.

The lower housing 111 may enclose the circumference of the yoke member 14. For example, the lower housing 111 may be provided in the shape of a cylinder with an opened top, and the yoke member 14 may be accommodated therein from the top.

The guide housing 112 may be a hollow member protruding upward, the hollow member connected to the lower housing 111 and the yoke member 14 that are coupled to each other on a lower side.

A lower end portion 1122 of the guide housing 112 may have a structure that fits into a groove formed in a coupling portion of the lower housing 111 and the upper side of the yoke member 14 and thus, may be inserted and fit into the groove.

The guide housing 112 may include a stepped portion 1121 recessed on the inner circumferential surface of the upper side thereof.

The upper housing 113 may be connected to the upper side of the guide housing 112. The upper housing 113 may be a hollow member to be inserted and fit into the inner circumferential surface of the stepped portion 1121. For example, the upper housing 113 may be provided in the shape with an opened top.

The upper housing 113 may be provided in the stepped portion 1121 after an edge of the elastic member 13 is provided in the lower side of the stepped portion 1121. In this example, the upper housing 113 may pressurize and fix the edge of the elastic member 13 from the top.

The yoke member 14 may be provided on the bottom of the inner space of the housing 11 to induce a flow of a magnetic field. For example, the yoke member 14 may distribute a line of magnetic force emitted from the radial magnet 15 to be concentrated in a coil part 122 accommodated in the yoke member 14.

The yoke member 14 may include a lower yoke 144 provided on the lower side of the lower housing 111, an inner yoke 141 protruding upward from the bottom of the lower housing 111, and an outer yoke 142 provided along the inner circumferential surface of the lower housing 111.

The inner yoke 141 may be a cylindrical member protruding upward from the center of the bottom of the inner space. The center line of the cylindrical inner yoke 141 may be on the same line as the center line of the cylindrical inner space.

The outer yoke 142 may be provided to enclose the inner circumferential surface of the lower housing 111. By the above structure, an annular accommodation space 143 may be formed between the outer yoke 142 and the inner yoke 141, and the radial magnet 15, a pole piece 16, and the coil part 122 may be accommodated in the accommodation space 143.

A step recessed in the upper side of the outer circumferential surface of the outer yoke 142 may be formed, and the step may form, with the upper end portion of the lower housing 111, a mounting groove 145 to which the lower end portion 1122 of the guide housing 112 may be coupled.

By the yoke member 14 and the pole piece 16, the flow of magnetic force formed by the radial magnet 15 may not be leaked outside of the yoke member 14 as shown in FIG. 3, and may be induced to pass as being concentrated in the accommodation space 143 where the coil part 122 is disposed, and thus great and uniform magnetic force may be applied along the entire coil part 122.

The radial magnet 15 may be a hollow magnetic body provided to enclose the outer circumferential surface of the inner yoke 141. For example, the radial magnet 15 may be magnetized in a radial direction. That is, a portion positioned inside based on the central axis of the radial magnet 15 and a portion positioned outside may have opposite magnetism.

The length of the radial magnet 15 measured in a vibration direction of the moving body 12 may be greater than a distance between the external diameter and the internal diameter of the radial magnet 15.

The pole piece 16 may be provided to cover the top surface of the radial magnet 15 to induce the magnetic force of the radial magnet 15 not to be leaked upward. For example, the top surface of the pole piece 16 may be on the same plane as the top surface of the inner yoke 141. By the above structure, a smooth magnetic path may be formed, and the overall volume of the wide-band actuator 1 may be reduced in comparison to the moving distance of the moving body 12.

On at least one of both sides of the pole piece 16 may be provided a cushion or a damper to alleviate an impact by collision with the moving body 12.

The moving body 12 may be provided in the inner space of the housing 11 and move in a vertical direction by magnetic force flowing in the accommodation space 143.

The moving body 12 may include a cylindrical mass body 121 provided to enclose the radial magnet 15 and the inner yoke 141, and the coil part 122 provided along the circumference of the mass body 121.

The mass body 121 may include a cylindrical insertion member 1212 with the lower side including a groove to accommodate the radial magnet 15 and the inner yoke 141, and a protruding member 1211 protruding upward from the insertion member 1212.

The mass body 121 may be formed of a material with a light mass, such as brass, for the drive in a wide frequency band. For example, the mass body 121 may be formed of a material with a lower density than the yoke member 14.

The mass body 121 may move vertically in the protruding direction of the inner yoke 141.

The insertion member 1212 may include a circular groove recessed from the bottom, and the lower edge portion thereof may be inserted into the accommodation space 143. That is, at least a portion of the inner yoke 141 and the radial magnet 15 may be inserted into the groove of the insertion member 1212.

The protruding member 1211 may protrude upward from the top of the insertion member 1212. For example, the protruding member 1211 may protrude upward from the center of the circular insertion member 1212.

The upper end portion of the protruding member 1211 may be exposed through the top of the housing 11. For example, in a state in which a current is not applied to the coil part 122, the upper end portion of the protruding member 1211 may be on the same perpendicular plane as the top surface of the upper housing 113.

The coil part 122 may be provided along the circumference of the circular insertion member 1212. For example, the coil part 122 may receive an alternating current from the controller 17 to form a magnetic field where the polarity alternately changes in a vertical direction.

The elastic member 13 may elastically support the moving body 12 from one side of the inner space. For example, the elastic member 13 may be formed of an elastic member in the shape of a flat plate connecting the inner circumferential surface of the housing and the mass body 121 in a plane direction perpendicular to a vertical direction.

The elastic member 13 may connect the upper housing 113 and the protruding member 1211. In this example, one side, that is, the edge portion, of the elastic member 13 may be inserted to fit into the inner circumferential surface of the stepped portion 1121 and fixed thereto. For example, the upper side of the edge of the elastic member 13 provided in the stepped portion 1121 may be connected to the lower end portion of the upper housing 113, such that the edge portion of the elastic member 13 may be fixed to the upper housing 113.

Meanwhile, another side of the elastic member 13 horizontally extending from the one side of the elastic member 13 fixed to the upper housing 113 may contact and be fixed to the outer circumferential surface of the protruding member 1211.

By the elastic member 13, the moving body 12 may be elastically supported while being spaced to be out of contact with the remaining elements except for the inner wall of the housing 11 and the elastic member 13.

The elastic member 13 may have a sufficiently high elasticity coefficient such that the side of the coil part 122 may stay fully inserted into the accommodation space 143, even in a state in which the moving body 12 is moved with the maximum displacement in an upward motion direction.

Meanwhile, based on an initial state in which electricity is not applied to the coil part 122, the center of the coil part 122 may be at a higher position than the center of the radial magnet 15. Further, the upper end of the coil part 122 may be at a lower position than the upper end of the pole piece 16. By the above structure, a sufficiently high vibration provision efficiency of the moving body may be achieved relative to the magnitude of the applied current, the downward movement distance of the moving body 12 may be secured, and further, the entire wide-band actuator 1 may be provided in a compact size.

Referring to FIG. 4, the magnitude of a force (N) applied to the coil part 122 according to the drive width (mm) in the upward motion direction of the moving body 12 may be determined based on the initial state in which a current is not applied to the coil part 122. According to the result shown in the graph of FIG. 4, it may be learned that if the drive width in the upward motion direction is about 0.5 mm to 0.7 mm (−0.5 mm to −0.7 mm in FIG. 4) based on the initial state, the magnitude of the force applied to the coil part 122 is maximized.

Thus, based on the initial state, the maximum displacement of the moving body 12 in the upward motion direction may range from 0.5 mm to 0.7 mm. In this example, the drive width of the moving body 12 in the vertical direction may also range from 0.5 mm to 0.7 mm.

If a current is not applied to the coil part 122, the center point of the coil part 122 may be at an upper position by a predetermined distance d than the center point of the radial magnet 15 based on the vertical direction.

By the structure in which the coil part 122 is positioned to be biased toward the upper side of the radial magnet 15, it is possible to achieve a structure advantageous in forming a great magnetic force to move upward or downward the coil part 122 having a polarity that vertically changes when a current is initially applied, and thus the response speed may increase effectively.

When an alternating current is applied to the coil part 122, the moving body 12 may perform a linear motion in a vertical direction in a state of being connected to the elastic member 13, and the magnetic flux direction of the radial magnet 15 and the motion direction of the moving body 12 may be formed to be perpendicular to each other.

The controller 17 may move the moving body 12 in the vertical direction by applying the alternating current to the coil part 122. For example, the controller 17 may adjust the waveform and the frequency of the current applied to the coil part 122. The controller 17 may drive the moving body 12 through a plurality of driving modes.

In a general vibration mode, the controller 17 may apply a sine wave of a frequency band between 100 Hz and 1 kHz to the coil part 122, thereby driving the moving body 12 in a wide frequency band to form a different haptic effect for each frequency band.

If the controller 17 applies a sine wave of a frequency band between 100 Hz and 1 kHz to the coil part 122, the moving body 12 may form a vibration force of more than 0.2 G, which corresponds to the magnitude of a general vibration force through which a human may sense a tactile sensation or a haptic effect.

In a tapping mode, the controller 17 may apply a rectangular wave of a frequency band between 1 Hz and 20 Hz to the coil part 122, thereby forming a haptic effect corresponding to “tapping” in which the amplitude of a vibration force formed by the moving body 12 intermittently changes.

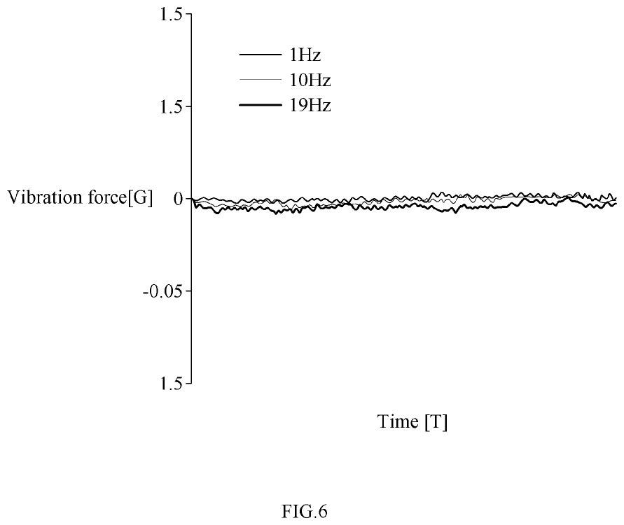

The controller 17 may apply an alternating current of a rectangular waveform of less than 20 Hz to the coil part 122 to form the haptic effect corresponding to tapping. The tapping mode will be described further in detail with reference to FIGS. 6 through 10.

By the wide-band actuator 1, in the entire moving process of the moving body 12, the yoke member 14 may have a structure provided to perfectly enclose the side of the coil part 122 in addition to the radial magnet 15. By the above structure, a great and uniform magnetic field may be applied throughout the entire portion of the coil part 122 during the entire period of the vertical motion performed by the moving body 12. Thus, a great vibration force, a high response speed, and drive stability may be secured.

Further, by forming the elastic member 13 in the shape of a flat plate at the same time forming the mass body 121 with a light material, the driving frequency may be extended to 500 Hz or further to 1 kHz, whereby the drive in a wide frequency band may be enabled.

FIG. 6 is a graph illustrating vibration forces measured when sine waves with frequencies less than 20 Hz are applied to a wide-band actuator according to an embodiment.

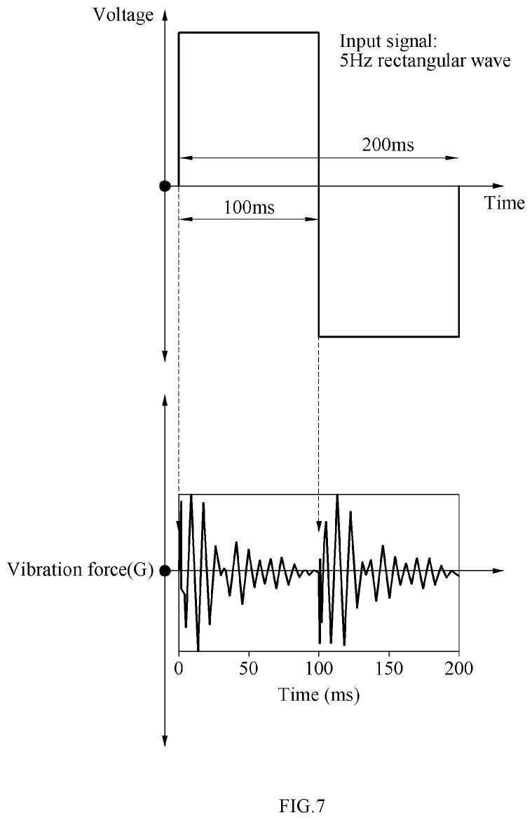

Referring to FIG. 6, it may be learned that vibration forces less than or equal to 0.01 G are produced when 1 Hz, 10 Hz, and 19 Hz sine waves are applied to the wide-band actuator 1. Through this, it may be learned that if a sine wave of less than or equal to 20 Hz is input into the wide-band actuator 1, noise responses imperceptible by a human being are observed. Meanwhile, response signals observed when low-frequency rectangular waves are applied will be described with reference to FIG. 7.

FIG. 7 is a graph illustrating an example of forming a haptic response corresponding to tapping when a 5 Hz rectangular wave is applied to a wide-band actuator according to an embodiment.

First, the first graph of FIG. 7 shows the form of a voltage when the controller 17 applies a rectangular wave with a frequency of 5 Hz to the coil part 122 for a cycle, and the second graph of FIG. 7 shows a vibration force G formed in the wide-band actuator 1 when the controller 17 applies a rectangular wave with a frequency of 5 Hz to the coil part 122.

Referring to FIG. 7, it may be learned that a haptic response different from a general vibration is formed when a rectangular wave corresponding to an ultra-low frequency band between 1 to 20 Hz is applied to the wide-band actuator 1. Through the haptic response, the wide-band actuator 1 may provide a tactile sensation of “tapping” to the user. That is, FIG. 7 shows an example of driving the wide-band actuator 1 in a “tapping mode”.

Referring to the graph on the bottom of FIG. 7, the haptic response driven in the tapping mode shows that the amplitude in the waveform of the vibration force changes in each cycle over time. The amplitude decreases approximately exponentially during a half cycle, in detail, shows a great value for a short time (about 20 ms) in the beginning and rapidly decreases in the middle and second half Through such a drastic difference in the amplitude, the user may sense a haptic effect such as intermittent tapping which is different from a general vibration.

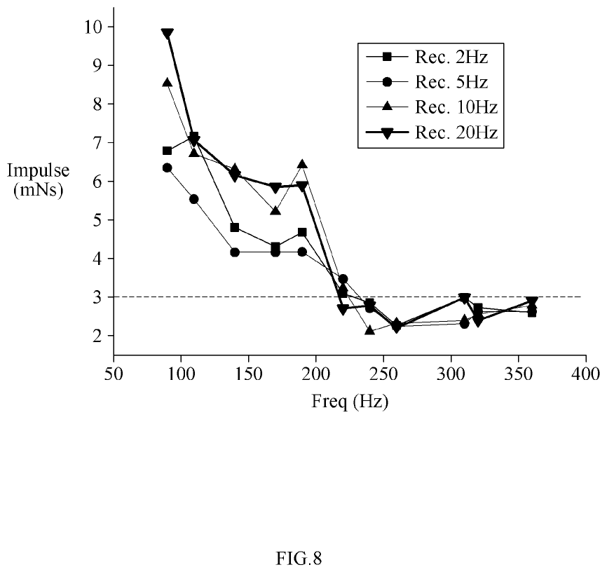

FIG. 8 is a graph illustrating impulses generated when rectangular waves of different ultra-low frequency bands are applied to a wide-band actuator according to an embodiment.

In detail, FIG. 8 is a graph showing impulses obtained by integrating, within a 50-ms period, vibration forces measured during the 50-ms period after applying rectangular waves corresponding to 2 Hz, 5 Hz, 10 Hz and 20 Hz to tactile actuators having various resonant frequencies between 80 Hz to 360 Hz.

The impulses may be obtained by integrating the vibration forces in the unit of 50 ms using Equation 1.

$$( Impulse ) = {\int }_{{t}_{0}}^{{t}_{0} + 50 m s} Fdt \qquad [ Equation 1 ]$$

In Equation 1, t_0 denotes the time at the instant of input of the waveform.

According to “Robotic Tactile Sensing Technologies and System, Springer Science & Business Media, (Jul. 29, 2012)”, it was verified that the minimum time required for a human to distinguish two stimuli with fingertips is 30 to 50 ms, and that an impulse of 3 mNs or more is required in a period of 0 to 50 ms for a human to recognize tapping with fingers as a result of the measurement subject to adults in their 20s to 40s.

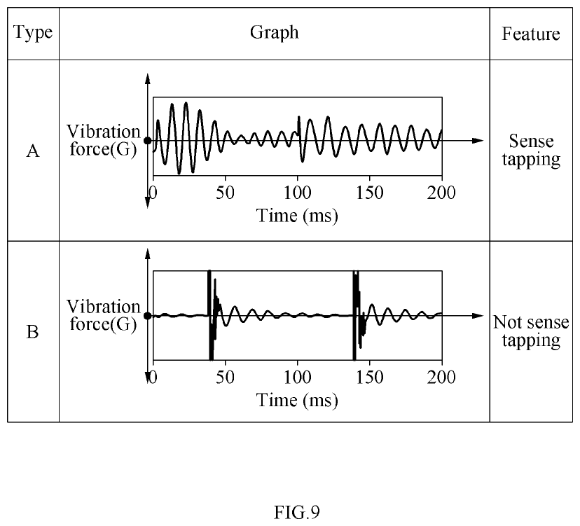

To acquire a desirable tapping effect from the wide-band actuator 1, a rectangular wave less than or equal to 20 Hz, which is the minimum frequency limit to provide a tactile sensation corresponding to a general vibration, needs to be applied as shown in FIG. 9, and a cumulative impulse during a 50-ms period, which is the minimum time required for an average person to distinguish two stimuli, should be greater than or equal to 3 mNs as confirmed above.

FIG. 9 illustrates graphs of vibration forces formed in Case A where a 5 Hz rectangular wave is applied to a wide-band actuator according to an embodiment and in Case B where a sine wave is applied thereto.

Referring to FIG. 9, if the sum of impulses in the 50-ms period exceeds 3 mNs as in Type A, a user may sense a tactile sensation of tapping.

Conversely, as a case of a haptic response with an extremely high attenuation rate similar to an impulse, if the sum of impulses in the 50-ms period does not exceed 3 mNs as in Type B, the user may not sense a tactile sensation of tapping.

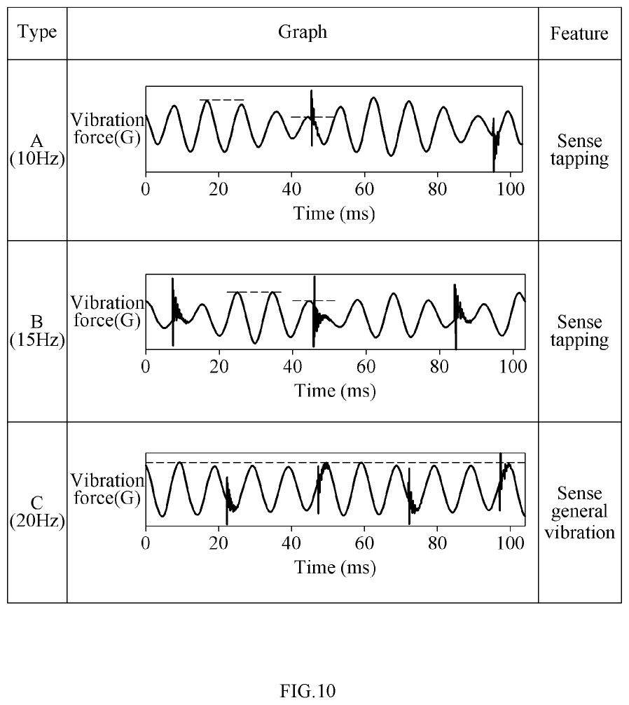

FIG. 10 illustrates graphs of vibration forces formed when rectangular waves of ultra-low frequency bands are applied to a wide-band actuator according to an embodiment.

In detail, FIG. 10 represents Type A, Type B, and Type C of the graphs of vibration forces measured when rectangular waves of 10 Hz, 15 Hz, and 20 Hz are input into the wide-band actuator 1.

Referring to FIG. 10, in Type A and Type B, the amplitude of the vibration force, that is, the height of the peak, changes over time, as indicated with broken lines. For example, a difference in height of the peak of the amplitude may be greater than or equal to 0.1 G. Further, it may be learned that the minimum interval in which the difference in height of the peak of the amplitude is greater than or equal to 0.1 G is formed to be greater than or equal to the minimum time, for example, 30 ms, required for a human to distinguish two stimuli with fingertips. In Type A and Type B, a user may sense a tactile sensation corresponding to tapping.

Conversely, in Type C, it may be learned that the interval of the cycle is formed to be short within the minimum time, for example, 30 ms, required for a human to distinguish two stimuli with fingertips, and that the difference in amplitude is less than 0.1 G and thus is not great, as indicated with a broken line. In this example, the user may sense a general vibration rather than tapping.

Thus, to operate the wide-band actuator 1 in a tapping mode, a rectangular wave of less than 20 Hz may be applied. That is, even when a rectangular wave is applied, the user may sense a general vibration rather than tapping since the rectangular wave shows a waveform the same as that of a sine wave if the frequency of the rectangular wave exceeds 20 Hz.

Consequently, in the tapping mode, the controller 17 may form a haptic effect corresponding to tapping by applying an alternating current of a rectangular waveform of less than 20 Hz to the coil part 122.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

1. A wide-band actuator, comprising:
a cylindrical housing having an inner space;
a yoke member provided in the inner space, the yoke member including a cylindrical inner yoke protruding upward from the center of the bottom of the inner space;
a hollow radial magnet provided to enclose the outer circumferential surface of the inner yoke;
a moving body including a cylindrical mass body provided to enclose the outer circumferential surface of the radial magnet, and a coil part provided along the circumference of the mass body; and
an elastic member configured to elastically support the moving body from one side of the inner space.

2. The wide-band actuator of claim 1, wherein the inner circumferential surface of the radial magnet and the inner yoke face each other, and the outer circumferential surface of the radial magnet and the coil part face each other, and
the inner circumferential surface and the outer circumferential surface of the radial magnet have opposite polarities.

3. The wide-band actuator of claim 2, wherein the length of the radial magnet measured in a vibration direction of the moving body is greater than a distance between the external diameter and the internal diameter of the radial magnet.

4. The wide-band actuator of claim 1, wherein the yoke member further comprises:
an outer yoke provided along the inner circumferential surface of the inner space; and
a lower yoke provided on the bottom of the inner space, and
the coil part is disposed in an accommodation space among the inner yoke, the outer yoke, and the lower yoke.

5. The wide-band actuator of claim 2, further comprising:
a pole piece provided to cover the top surface of the radial magnet.

6. The wide-band actuator of claim 5, wherein based on a vertical direction, the center point of the coil part is at an upper position than the center point of the radial magnet.

7. The wide-band actuator of claim 5, wherein based on a vertical direction, the upper end of the coil part is at a lower position than the upper end of the pole piece.

8. The wide-band actuator of claim 1, wherein the elastic member is provided in the shape of a flat plate connecting the inner space of the housing and the mass body in a plane direction perpendicular to a vertical direction.

9. The wide-band actuator of claim 8, wherein the housing comprises:
a lower housing enclosing the circumference of the yoke member; and
a guide housing with the lower side connected to the lower housing and the yoke member, the guide housing including a stepped portion recessed on the inner circumferential surface of the upper side, and
the edge of the elastic member is provided in the stepped portion of the guide housing.

10. The wide-band actuator of claim 9, wherein the housing further comprises:
a hollow upper housing provided in the stepped portion to pressurize and fix the edge of the elastic member provided in the stepped portion from the top.

11. The wide-band actuator of claim 1, wherein the mass body comprises:
a cylindrical insertion member with the lower side including a groove to accommodate the radial magnet and the inner yoke; and
a protruding member protruding upward from the center of the insertion member.

12. The wide-band actuator of claim 11, wherein the protruding member protrudes toward the upper side of the housing.

13. The wide-band actuator of claim 11, wherein the elastic member is provided in the shape of a flat plate connecting the inner space of the housing and the protruding member in a plane direction perpendicular to a vertical direction.

14. The wide-band actuator of claim 2, further comprising:
a controller configured to apply an alternating current to the coil part,
wherein when the controller applies a sine wave of a frequency band between 100 Hz to 1 kHz to the coil part, the moving body forms a vibration force of 0.2 G or greater.

15. The wide-band actuator of claim 2, further comprising:
a controller configured to apply an alternating current to the coil part,
wherein when the controller applies an alternating current of a rectangular waveform of a frequency band between 1 Hz to 20 Hz to the coil part, a cumulative impulse formed by the moving body within a unit interval of 50 ms is 3 mNs or greater, such that a haptic effect corresponding to tapping is formed.

16. A wide-band actuator, comprising:
a housing having an inner space;
a yoke member including an outer yoke provided along the inner circumferential surface of the inner space, and an inner yoke protruding upward from the bottom of the inner space;
a radial magnet provided to enclose the outer circumferential surface of the inner yoke;
a moving body including a mass body configured to move in a protruding direction of the inner yoke in a separation space formed between the radial magnet and the outer yoke, and a coil part provided in the mass body; and
an elastic member configured to elastically support the moving body from one side of the inner space.

17. The wide-band actuator of claim 16, wherein the yoke member further comprises a lower yoke connecting the bottom of the outer yoke and the bottom of the inner yoke.

18. A wide-band actuator, comprising:
a housing having an inner space;
a yoke member including an outer yoke provided along the inner circumferential surface of the inner space, and an inner yoke protruding upward from the bottom of the inner space;
a radial magnet provided to enclose the outer circumferential surface of the inner yoke;
a moving body including a mass body configured to move in a protruding direction of the inner yoke in a separation space formed between the radial magnet and the outer yoke, and a coil part provided in the mass body; and
a pole piece provided to cover the top surface of the radial magnet.

19. A wide-band actuator, comprising:
a lower housing having an inner space;
a yoke member to be inserted into the lower housing, the yoke member including a first step recessed on the outer circumferential surface of the upper side thereof;
a radial magnet connected to the yoke member;
a guide housing with the lower end portion to be coupled to a mounting groove formed by the lower housing and the step;
an elastic member seated in a second step recessed on the inner circumferential surface of the upper side of the guide housing; and
a moving body connected to the elastic member, the moving body including a coil part configured to interact with the radial magnet.

20. The wide-band actuator of claim 19, further comprising:
an upper housing to be inserted into the second step to fix the elastic member, in a state in which the elastic member is seated in the second step.

21. The wide-band actuator of claim 20, wherein the upper housing has an opened top, and
the moving body further comprises:
a protruding member exposed through the opened top of the upper housing.
